(19) United States
(12) Patent Application Publication
(10) Pub. No.: US 2013/0271336 A1
(43) Pub. Date: Oct. 17, 2013

(54) DUAL POLARIZED RADIATING DIPOLE ANTENNA

(71) Applicants: Jérôme Plet, Lannion (FR); Aurélien Hilary, Lannion (FR); Gilles Coquille, Lannion (FR); Thomas Julien, Lannion (FR); Gaetan Fauquert, Lannion (FR)

(72) Inventors: Jérôme Plet, Lannion (FR); Aurélien Hilary, Lannion (FR); Gilles Coquille, Lannion (FR); Thomas Julien, Lannion (FR); Gaetan Fauquert, Lannion (FR)

(73) Assignee: ALCATEL LUCENT, Paris (FR)

(21) Appl. No.: 13/879,867

(22) PCT Filed: Oct. 25, 2011
(86) PCT No.: PCT/EP2011/068681

§ 371 Date: Jul. 2, 2013

(30) Foreign Application Priority Data
Oct. 27, 2010 (FR) 1058828

(51) Int. Cl. H01Q 9/16

(52) U.S. Cl. CPC H01Q 9/16
USPC 343/796

(57) ABSTRACT

The dual polarised radiating element comprises four dipoles each comprising one stand and two arms. A first arm and a second arm belonging to two adjacent dipoles, form a straight radiating strand composed of a single part and the four radiating strands are arranged so as to form a disjoint square at the corners. The antenna comprises at least one first radiating element operating in a first frequency band and at least one second radiating element operating in a second frequency band and having at least one dipole that is arranged at the centre of the square formed by the radiating strands of the first radiating element, the radiating elements being arranged above a common reflector such that the transverse strands of the first radiating elements are located between two adjacent second radiating elements.

### CROSS-REFERENCE

This application is based on French Patent Application No. FR1058828 filed Oct. 27, 2010, the disclosure of which is hereby incorporated by reference thereto in its entirety, and the priority of which is hereby claimed under 35 U.S.C. §119.

### TECHNICAL FIELD

This invention relates to the field of telecommunication antennas transmitting radioelectric waves in the hyperfrequency range, using radiating elements.

In particular, the invention relates to a radiating element that will operate in any frequency band, particularly in a low frequency band of a multiband antenna, like those present particularly in telecommunication antennas. Such a radiating element can be used equally well in a single band antenna and in a multiband antenna, called panel antennas, particularly intended for use as cell phone applications.

### BACKGROUND

Cell telephony uses miscellaneous frequency bands corresponding to different known telecommunication systems. Several telecommunication systems are presently used simultaneously, for example such as the “Global System for Mobile communications” GSM (870-960 MHz), the “Digital Cellular System” DCS (1710-1880 MHz), and the “Universal Mobile Telephone Service” UMTS (1900-2170 MHz). Multiband antennas derived from the combination of several series of radiating elements belonging to frequency bands in different telecommunication systems are used within a single antenna chassis, in order to avoid increasing the number of previously installed antennas.

For example, there are two-frequency band or three-frequency band antennas in which radiating elements assigned to each frequency are aligned either parallel to each other according to a longitudinal periodic structure, for example staggered and alternating, so as to create a similar radioelectric environment for all radiating elements corresponding to the same frequency. These configurations significantly increase the width of the antenna and degrade the radiation performances, at least for the highest frequency.

Two configurations are frequently used in order to make a two-frequency band antenna operating in two distinct frequency bands with orthogonal polarisations.

A first so-called “side by side” configuration consists of a first alignment of radiating elements formed by two orthogonal cross dipoles operating on a first frequency band, and a second alignment of radiating elements formed by two orthogonal cross dipoles operating on a second frequency band. The two rows are parallel to each other and are separated by at least half a wavelength of the highest frequency band. This “side by side” configuration has good performances, but the width of the antenna is too large. The “side by side” configuration has developed towards a “colinear” configuration to reduce the antenna width.

In a second so-called “colinear” (or “concentric”) configuration, radiating elements formed by four dipoles in a square formation are arranged concentrically to operate in a first frequency band around elements formed by two radiating cross dipoles operating in a second frequency band. All these elements are aligned along the same axis and are placed above a reflector in a single chassis. This configuration is too large for a long dipole length, and the external radiating element can disturb the adjacent radiating elements.

For both types of configuration, there is a strabismus effect of the azimuth diagram caused by asymmetry in the azimuth alignment plane of elements radiating at high frequency. A strong degradation in cross polarisation is also observed in the ±60° angular section due to this asymmetry.

### SUMMARY

New services are more demanding in terms of passband and they require the highest possible gain and very high isolation levels between radiating elements in a more compact environment, particularly to satisfy digital signal processing requirements.

Therefore, the purpose of this invention is to disclose a dual polarised radiating element that can be integrated into a multiband antenna in colinear configuration leading to a low cost, easily assembled and compact structure.

Another purpose of the invention is to disclose a dual polarised radiating element capable of operating in a given frequency range with specific radiating characteristics in the azimuth.

Another purpose of the invention is to disclose a dual polarised radiating element operating in one frequency band, in which the geometry of the element has a limited impact on the performances of another radiating element concentric with it and operating in another frequency band.

Another purpose of the invention is to disclose the narrowest possible antenna designed with this radiating element.

The purpose of this invention is a dual polarised radiating element comprising four dipoles each comprising one stand and two arms. A first arm and a second arm belonging to two adjacent dipoles forming a straight radiating strand composed of a single part, the four radiating strands being arranged so as to form a disjoint square at the corners. The two arms of each dipole are thus orthogonal to each other,

In this configuration, the dipoles are deliberately isolated from each other to reduce inter-modulation problems. The shape of the radiating elements is designed so as to obtain excitation that is as eccentric as possible, in order to achieve a networking effect.

According to one preferred embodiment, each of the radiating strands is composed of a single conducting part with folded prolongations at each end of the radiating strand.

The prolongations of each conducting part are preferably folded at 90° from the plane of the radiating strands.

According to one aspect, at least one of the prolongations of each part forms a half-stand of the stand of one of the dipoles.

According to another aspect, each dipole is powered by a power supply system comprising a power supply line and at least one ground plane that is one of the half-stands of the stand of one of the dipoles.

According to a first variant, the power supply system for a dipole with a stripline structure is formed from a power supply line surrounded by two ground planes, each ground plane being one of the half-stands of the stand of one of the dipoles.

A stripline or microstrip type power supply line arranged vertically reduces costs and simplifies the assembly relative to the known radiating elements.

According to a second variant, the power supply system for a dipole has a microstrip structure formed from a power supply line adjacent to a ground plane that is the stand of the contiguous dipole.

The invention also discloses a radiating device comprising a first radiating element operating in a first frequency band like that described above, and at least one second radiating element operating in a second frequency band and comprising at least one dipole, arranged at the centre of the square formed by the radiating strands of the first radiating element, the radiating elements being arranged above a common reflector.

The invention also discloses an antenna comprising at least one first radiating element operating in a first frequency band, like that described above, and at least one second radiating element operating in a second frequency band. The first and second radiating elements are aligned and arranged above a common reflector such that the transverse strands of the first radiating elements are located between two adjacent second radiating elements.

According to one variant embodiment, partitions may be arranged parallel to the alignment of the second radiating elements, inside the alignment of the first radiating elements.

According to another variant, parallelepiped, cubic or rectangular shaped cavities are arranged around the second radiating elements, inside the alignment of the first radiating elements.

The advantages of this invention are that it reduces the size and the space occupied by multiband antennas, and particularly reduces the width by about 15%. It also enables an improvement in RF performances while making the antenna symmetric. Finally, it reduces costs and simplifies the assembly of the antenna.

### DETAILED DESCRIPTION

Other characteristics and advantages of this invention will become clear after reading the following detailed description of one embodiment, obviously given for illustrative and non-limitative purposes, with reference to the appended drawings in which

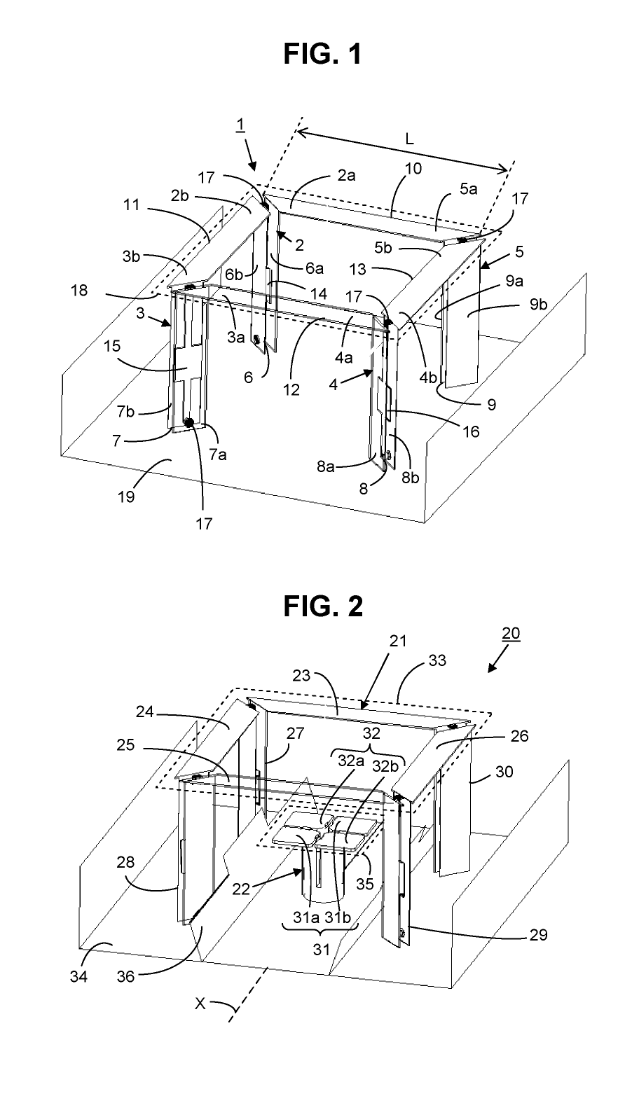

FIG. 1 diagrammatically shows a perspective view of an embodiment of a radiating element,

FIG. 2 diagrammatically shows a perspective view of a first embodiment of a radiating element,

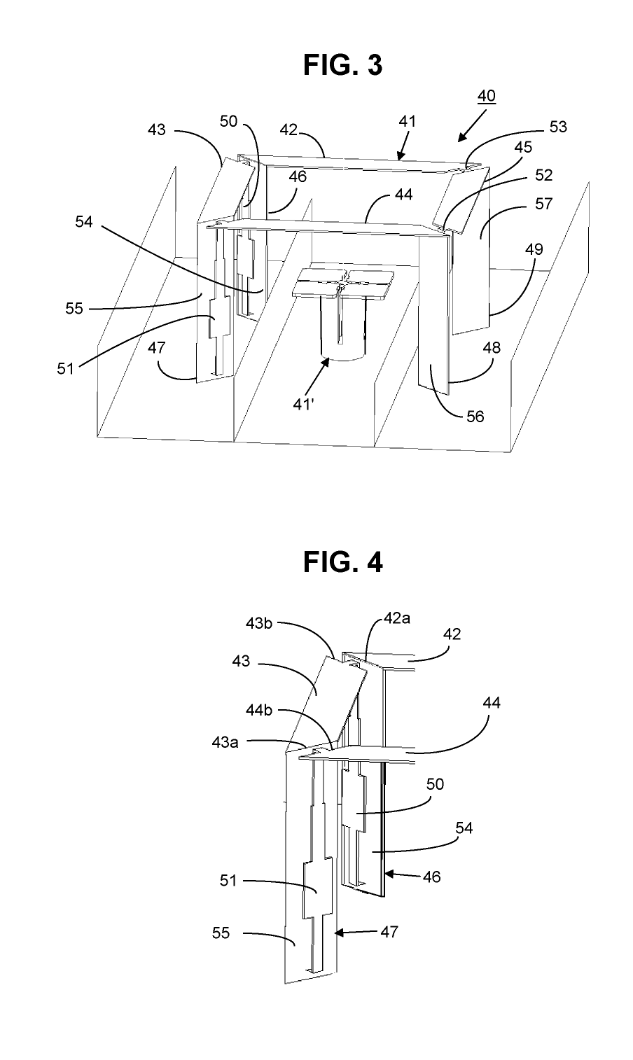

FIG. 3 diagrammatically shows a perspective view of a second embodiment of a radiating element,

FIG. 4 diagrammatically shows a detail of the radiating device in FIG. 3,

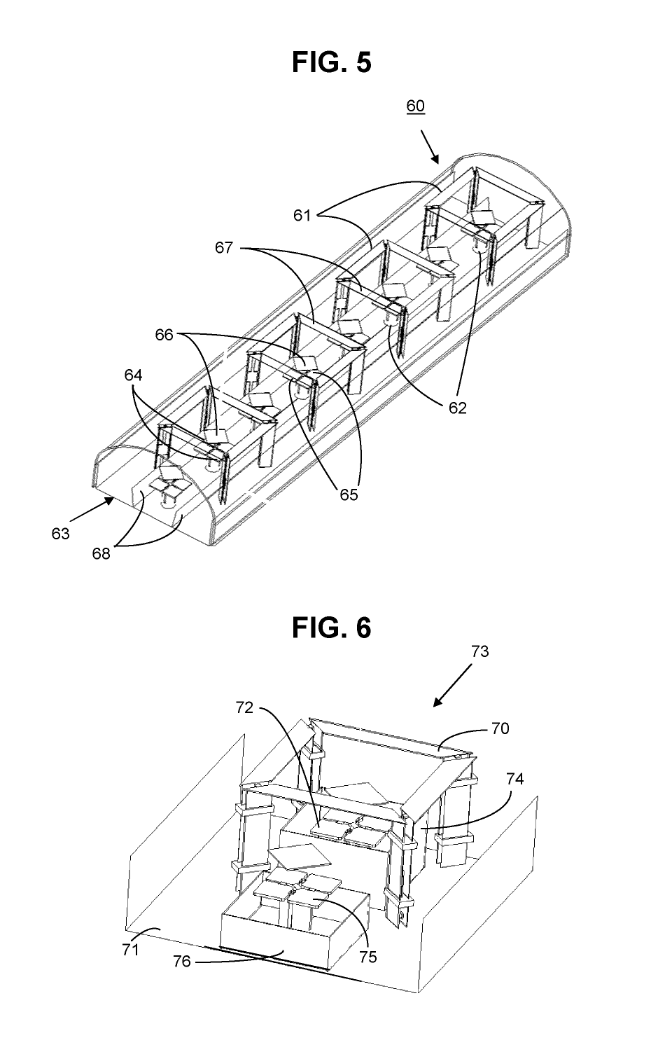

FIG. 5 diagrammatically shows a perspective view of one embodiment of an antenna,

FIG. 6 diagrammatically shows a partial view of another embodiment of an antenna.

The drawings contain elements that can help to better understand the description, and also to contribute to the definition of the invention. Identical elements in each of these figures have the same reference numbers.

In the embodiment illustrated in FIG. 1, a radiating element 1 comprises four dipoles 2, 3, 4, 5. Each dipole 2, 3, 4, 5 comprises a stand 6, 7, 8, 9 each supporting a pair of arms 2a, 2b; 3a, 3b; 4a, 4b; 5a, 5b respectively. The two arms 2a, 2b; 3a, 3b; 4a, 4b; 5a, 5b of each dipole 2, 3, 4, 5 are oriented to be perpendicular to each other. Each stand 6, 7, 8, 9 comprises two half-stands 6a, 6b; 7a, 7b; 8a, 8b and 9a, 9b each of which has one internal side face facing the other and one side face that faces outwards.

The colinear arms 2a and 5a belonging to dipoles 2 and 5 respectively form a radiation strand 10 composed of a single straight conducting part, for example a thin metal sheet, that prolongs on each end of the radiating strand 10. Consequently, the straight radiating strand 10 is common to the two adjacent dipoles 2, 5. Each prolongation of the conducting part is folded to form the half-stands 6a and 9a of the stands 6 and 9 of the dipoles 2 and 5, respectively. Similarly, the colinear arms 2b and 3b of dipoles 2 and 3 respectively form a radiating strand 11, each folded prolongation of the conducting part forming the half-stands 6b and 7b of the stands 6 and 7 of dipoles 2 and 3 respectively.

Also similarly, the colinear arms 3a and 4a of the dipoles 3 and 4 respectively form a radiating strand 12, each folded prolongation of the conducting part forming half-stands 7a and 8a of stands 7 and 8 of dipoles 3 and 4 respectively. Also similarly, the colinear arms 4b and 5b of dipoles 4 and 5 respectively form a radiating strand 13, each folded prolongation of the conducting part forming half-stands 8b and 9b of stands 8 and 9 of dipoles 4 and 5 respectively. For example, the radiating strands 10, 11, 12, 13 may be composed of thin folded metal sheets that are identical to each other. The radiating strands 10, 11, 12, 13 are arranged so as to form a disjoint square at the corners, the length L of each side of the square can vary from a quarter to a half wavelength of the central operating frequency of the radiating element 1.

Power supply systems for dipoles 2, 3, 4, 5 have stripline structure composed of a power supply line 14, 15, 16, that is the conducting layer placed between two ground planes, from which it is separated by a dielectric layer. The power supply lines 14, 15, 16 are located at the four corners of the interrupted square delimited by the four radiating strands 10, 11, 12, 13. The diagonally opposite power supply lines 14 and 16 generate the same polarisation, in the present case at ±45°. The symmetry of the power supply makes the radiation diagram symmetry. The half-stands 7a and 8a are shown as being transparent in FIG. 1 so that the power supply lines 15 and 16 can be seen, to facilitate understanding. The power supply line 15 is a conducting layer that is arranged between the half-stands 7a and 7b of the stand 7 of the dipole 3 that act as the ground plane. Similarly, each power supply system is composed of a power supply line 14, 15, 16, that is the conducting layer, arranged between the half-stands 6a, 6b; 8a, 8b; 9a, 9b forming the stands 6, 8 and 9 of the dipoles 2, 4 and 5 respectively, in pairs. The half-stands 6a, 6b; 8a, 8b; 9a, 9b act as the ground plane for the conducting layer that they surround. Note that the radiating strands 10, 11, 12, 13 are disjoint and are separated by a space, the width of which can be consolidated by inserting isolating packing parts 17, for example made of plastic, thus separating the conducting parts from each other. The difference is preferably kept constant so to achieve reproducible performances.

The power supply lines 14, 15, 16 are connected to four opposite coaxial cables, and are coupled in pairs using a power splitter, so as to generate two orthogonal polarisations. The prolongations of each conducting part forming the half- stands 6a, 6b; 7a, 7b; 8a, 8b; 9a, 9b, respectively, are folded at 90° from the plane 18 of the radiating strands 10, 11, 12, 13. The power supply lines 14, 15, 16 thus extend vertically between the reflector 19, acting as the ground plane for the radiating element 1 located in it, and one of the ends of each of the corresponding radiating strands 10, 11, 12, 13 of the radiating element 1. The verticality of the power supply lines 14, 15, 16 contributes to preventing interactions between the radiating element 1 and adjacent radiating elements. The radiating element 1 has a significant advantage in terms of cost because it uses mainly thin metal sheets, cut out and folded identically, and inexpensive and easily assembled stripline power supply systems.

The radiating element was made with a front-to-back ratio of more than 25 dB, cross polarisation of more than 15 dB along the line of the antenna, and a mid-power aperture in azimuth of 65°. However, it is perfectly possible to use it for an application for which the mid-power aperture would be 90°.

We will now consider FIG. 2 that shows a first embodiment of a two-frequency band radiation device 20 comprising a radiating element 21 operating for example in a low frequency LF band and a radiating element 22 operating for example in an HF band of higher frequencies. In particular, the low frequency band can cover frequencies varying from 698 MHz to 960 MHz (in particular the GSM system) and in particular the high frequency band can cover frequencies from 1710 MHz to 2700 MHz (particularly DCS, UMTS and LTE systems)

The LF radiating element 21 comprises four radiating strands 23, 24, 25, 26, belonging to four dipoles 27, 28, 29, 30, that are arranged so as to form a square around the HF radiating element 22. The radiating strands 23, 24, 25, 26 of the LF radiating element 21 are arranged in a plane 33 parallel to the antenna reflector 34. The geometry of the LF radiating element 21 limits the impact of its presence on the performances of the HF radiating element 22 located inside the square formed by its arms 23, 24, 25, 26. The width of the LF radiating element 21 is chosen to be equal to the distance separating two HF radiating elements 22. Consequently, all transverse strands 23, 25, that are practically perpendicular to the longitudinal X axis of the multi band antenna, are located symmetrically at mid-distance between two adjacent HF radiating elements 22. The vertical power supply lines of the dipoles are then arranged at equal distance from the two adjacent HF radiating elements 22 and thus all elements 22 are affected in the same way.

The HF radiating element 22 comprises two dipoles 31 and 32, associated orthogonally in a dual cross polarisation arrangement and each comprising two arms 31a, 31b and 32a, 32b one prolonging the other, arranged in a plane 35 parallel to the antenna reflector 34.

The plane 33 of the radiating strands 23, 24, 25, 26 of the LF element 21 is placed above the plane 35 of arms 31a, 31b and 32a, 32b of the HF element 22. The radiating strands 23, 24, 25, 26 of dipoles 27, 28, 29, 30 of the LF radiating element 21 and the arms 31a, 31b and 32a, 32b of the dipoles 31 and 32 of the HF radiating element 22 are placed above the same reflector 34 that acts as their common ground plane.

A variant embodiment of a radiating device 40 is shown in FIGS. 3 and 4. The two-frequency band radiating device 40 comprises a radiating element 41 operating for example in an LF low frequency band and a radiating element 41′ operating for example in an HF band with higher frequencies. The LF radiating element 41 comprises four radiating strands 42, 43, 44, 45 belonging to the four dipoles 46, 47, 48, 49.

Each of the dipoles 46, 47, 48, 49 is provided with a microstrip type power supply system. Each power supply system comprises a power supply line 50, 51, 52, 53 adjacent to a ground plane composed of the stand 54, 55, 56, 57 of the dipole 46, 47, 48, 49 contiguous with the powered dipole. The power supply line 50, 51, 52, 53 thus forms a vertical connection between one of the ends of a corresponding radiating strand 42, 43, 44, 45 of the LF radiating element 41 and the coaxial cable that powers it.

As shown in detail in FIG. 4, each prolongation 43a, 43b of the conducting part forming the radiating strand 43 is folded at 90°. One of the prolongations 43a forms the stand 55 of the dipole 47 and the other prolongation 43b forms the power supply line 50 of the dipole 46. Similarly, one of the folded prolongations 44b of the part forming the radiating strand 44 forms the power supply line 51 of the dipole 47, and one of the folded prolongations 42a of the radiating strand 42 forms the stand 54 of the dipole 46.

Thus, the stand 54, 55, 56, 57 belonging to one of the dipoles 46, 47, 48, 49 acts as the ground plane for the power supply line 50, 51, 52, 53 that is contiguous with it. Consequently, the dipoles 46, 47, 48, 49 are asymmetric. This solution can reduce the number of parts necessary to make the radiating element 41 from eight parts for known devices (4 dipoles with their 4 power supply lines) to four parts for the radiating element 41 according to this embodiment (4 dipoles in which the power supply is integrated) and consequently simplifies assembly of the radiating element 41. The verticality of the power supply lines 48, 49, 50, 51 also contributes to preventing interactions between the radiating element 41 operating in the LF band and adjacent radiating elements 41′ operating in the HF band.

FIG. 5 shows an antenna 60 operating in wide band (700 MHz-960 MHz) comprising radiating elements 61 operating in the LF band, similar to what is shown in FIG. 1, and radiating elements 62 operating in the HF band arranged on a common reflector 63. An HF radiating element 62 comprises two coplanar dipoles 64, 65 associated orthogonally in a dual cross polarisation arrangement and a directional element 66 that is not interconnected to the dipoles 64, 65 and that is arranged above the dipoles 64, 65. The radiating elements 61 are arranged such that their transverse strands 67 are located between two HF radiating elements 62.

Reflecting longitudinal partitions 68 may be located on the reflector 62 on each side of the alignment of the HF radiating elements 64, so as to optimise the radiation diagram in the horizontal plane of the antenna 60. These partitions may have different dimensions and different shapes, for example like the partition 36 shown in FIG. 2.

The combined use of a radiation element like that described above operating on a low frequency band with a radiating element operating on a high frequency band gives an antenna operating on a wide band that is narrower than known antennas.

Alternately, cubic or cuboid cavities of different sizes could be used instead of the partitions, as shown in FIG. 6. An LF element 70, similar to that shown in FIG. 1, is placed on an antenna reflector 71. An HF element 72 is placed at the centre of the square formed by the radiating strands of the LF element 70 to form a radiating device 73. The HF element 72 is surrounded by a cubic cavity 74. An HF element 75 located close to the radiating device 73 is also surrounded by a cubic cavity 76 that is less tall.

Obviously, this invention is not limited to the embodiments described but it can be used in many variants that could be developed by those skilled in the art without going outside the scope of this invention. Although the invention is described for a radiating element operating particularly in the LF band in a two-frequency band application, the radiating element can be used regardless of the frequency necessary for the final application. This radiating element could also be used in a single frequency wide band antenna or in three-frequency band or multiband antenna.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. Dual polarised radiating element comprising four dipoles each comprising one stand and two orthogonal arms, wherein a first arm and a second arm belonging to two adjacent dipoles and being colinear form a straight radiating strand composed of a single part, and the four radiating strands are arranged so as to form a square that is disjoint at the corners.

2. Radiating element according to claim 1, wherein the radiating strand is composed of a single conducting part and the end of the conducting part is folded so as to form folded prolongation at the end of the radiating strand.

3. Radiating element according to claim 2, wherein the end of the conducting part forming folded prolongation is folded at 90° from the plane of the radiating strands.

4. Radiating element according to claim 2, wherein the stand comprising two half-stands, the prolongation of the conducting part forms the half-stand of the stand of one of the dipoles involved in the radiating strand.

5. Radiating element according to claim 1, wherein the dipole is powered by a power supply system comprising a power supply line and at least one ground plane that is the half-stand of the stand of the dipole.

6. Radiating element according to claim 5, wherein the power supply system for a dipole has a stripline structure formed from a power supply line surrounded by two ground planes, each ground plane being one of the half-stands of the stand of the dipole.

7. Radiating element according to claim 5, wherein the power supply system for a dipole has a microstrip structure formed from a power supply line adjacent to a ground plane that is the stand of the dipole.

8. Radiating device comprising a first radiating element operating in a first frequency band according to claim 1, and at least one second radiating element operating in a second frequency band and comprising at least one dipole, arranged at the centre of the square formed by the radiating strands of the first radiating element, the radiating elements being arranged above a common reflector.

9. Antenna comprising at least one first radiating element operating in a first frequency band according to claim 1, and at least one second radiating element operating in a second frequency band, the first and second radiating elements being aligned and arranged above a common reflector such that the transverse strands of the first radiating elements are located between two adjacent second radiating elements.

10. Antenna according to claim 9, wherein partitions are arranged parallel to the alignment of the second radiating elements, inside the alignment of the first radiating elements.

11. Antenna according to claim 9, in which parallelepiped, cubic or rectangular shaped cavities are arranged around the second radiating elements, inside the alignment of the first radiating elements.
